(19) United States
(12) Patent Application Publication
(10) Pub. No.: US 2013/0188053 A1
(43) Pub. Date: Jul. 25, 2013

(54) SPORTS CAMERA

(71) Applicants: Richard S. Slevin, Los Altos Hills, CA (US); Margarita Kovats Slevin, Los Altos Hills, CA (US)

(72) Inventors: Richard S. Slevin, Los Altos Hills, CA (US); Margarita Kovats Slevin, Los Altos Hills, CA (US)

(21) Appl. No.: 13/744,329

(22) Filed: Jan. 17, 2013

Related U.S. Application Data
(60) Provisional application No. 61/587,646, filed on Jan. 17, 2012.

(51) Int. Cl. H04N 7/18

(52) U.S. Cl. CPC H04N 7/18
USPC 348/158

(57) ABSTRACT

A system and method for a gun-mounted camera with lensing that mimics a magnification scope, such as could be used on a rifle. Some preferred embodiments use a digital zoom while maintaining a native pixel count by using a larger sensor, and further use a combination of decimating an image for low magnification and windowing for higher magnification. Essentially some preferred embodiments change a field of view while maintaining the same number of pixels in the video output. Most preferably matching the field of view of a rifle scope with the press of a button.

### CROSS REFERENCE TO RELATED APPLICATIONS

This application claims benefit of U.S. Patent Application No. 61/587,646 filed 17 Jan. 2012, the contents of which in its entirety is expressly incorporated by reference thereto for all purposes.

### BACKGROUND OF THE INVENTION

The present invention relates generally to sports imagers, and more specifically, but not exclusively, to a portable HD/DVI imagers that may be used in sporting activities and incorporated into sporting equipment.

There are many imaging solutions with sporting activities, such as hunting (e.g., a camera on a bow, shotgun, pistol, paintball gun, or the like) and bicycling, skiing, snowboarding, surfing, skateboarding, roller skating, hiking, horseback riding, and the like. Participants in these sports that use imagers are constantly in search of products with improved features. In the hunting scenario, it would be an advantage to have a gun-mounted camera with lensing that could mimic a magnification scope.

What is needed is a system and method for a gun-mounted camera with lensing that mimics a magnification scope, such as could be used on a rifle.

### BRIEF SUMMARY OF THE INVENTION

Disclosed is a system and method for a gun-mounted camera with lensing that mimics a magnification scope, such as could be used on a rifle. Some preferred embodiments use a digital zoom while maintaining a native pixel count by using a larger sensor, and further use a combination of decimating an image for low magnification and windowing for higher magnification. Essentially some preferred embodiments change a field of view while maintaining the same number of pixels in the video output. Most preferably matching the field of view of a rifle scope with the press of a button.

The following summary of the invention is provided to facilitate an understanding of some of technical features related to imagers used in sporting activities, and is not intended to be a full description of the present invention. A full appreciation of the various aspects of the invention can be gained by taking the entire specification, claims, drawings, and abstract as a whole.

The imaging solutions of the disclosed embodiments for a gun, pistol, paintball, airsoft, rifle, shotgun, or bow. The imaging solution is useful in various contexts, including training, hunting, target practice, skeet, paint ball, archery, and other activities, interchangeable with adapters for mounting variously to pistols, rifles, and shotguns.

Other features, benefits, and advantages of the present invention will be apparent upon a review of the present disclosure, including the specification, drawings, and claims.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a first sports cam designed for guns and bows;

FIG. 2 illustrates a sporting system including the sports cam of FIG. 1 attached to a handgun;

FIG. 3 illustrates a second sports cam designed for outdoor activities;

FIG. 4 illustrates a front perspective view of the sports cam shown in FIG. 3; and

FIG. 5 illustrates a side view of the sports cam shown in FIG. 3 including a mounting rail.

### DETAILED DESCRIPTION OF THE INVENTION

Embodiments of the present invention provide a system and method for a gun-mounted camera with lensing that mimics a magnification scope, such as could be used on a rifle. The following description is presented to enable one of ordinary skill in the art to make and use the invention and is provided in the context of a patent application and its requirements.

Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

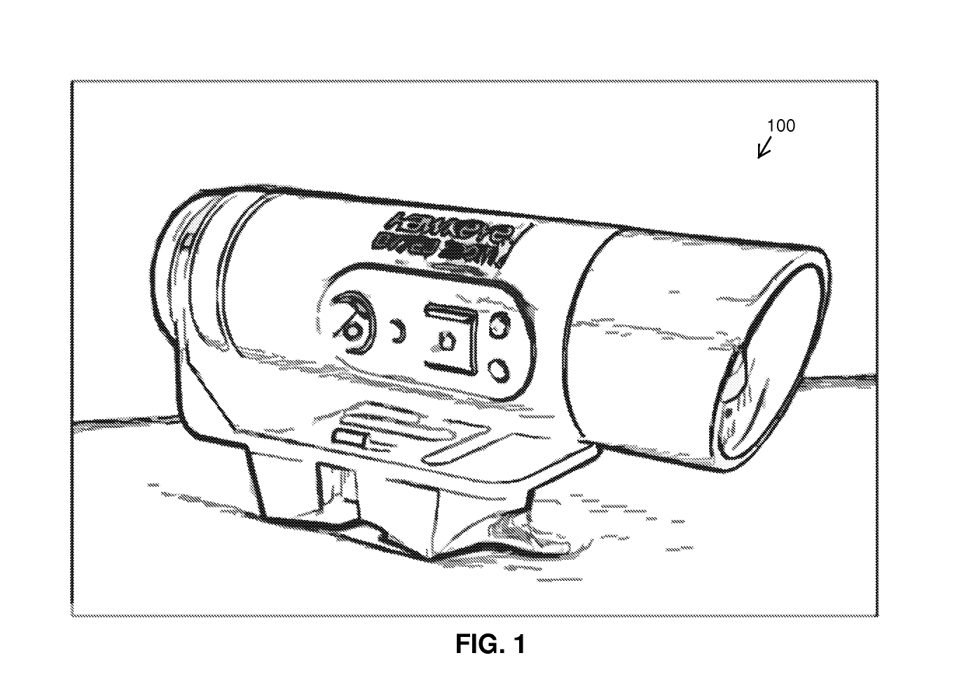

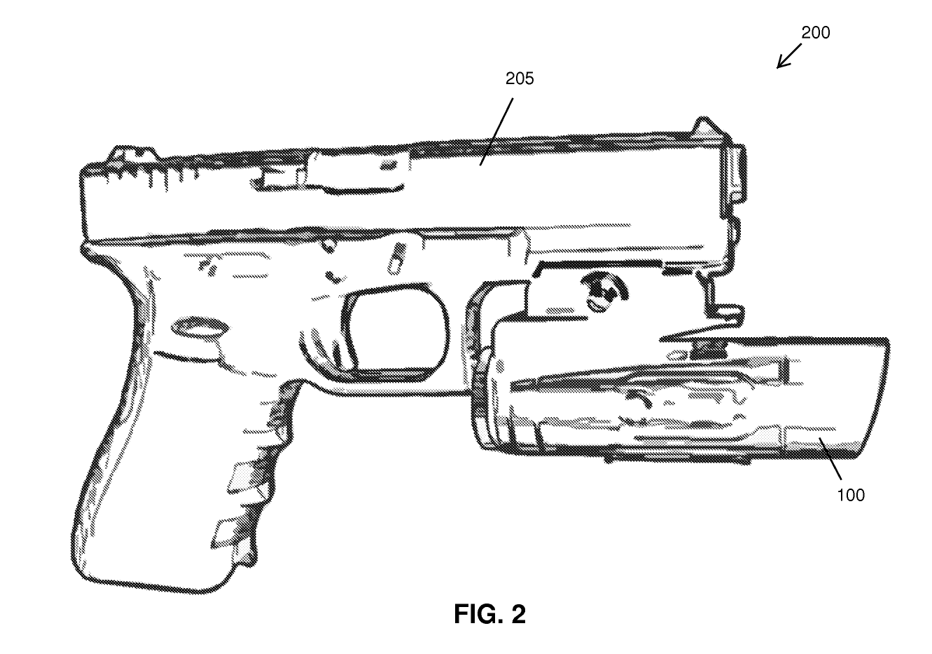

FIG. 1 illustrates a first sports cam 100 designed for guns and bows, and FIG. 2 illustrates a sporting system 200 including sports cam 100 of FIG. 1 attached to a handgun 205. Sports cam 100 is optimized for guns and bows. With a preferred diameter of 1.125 inches (range less than 2 inches) and a preferred overall length of 3.75 inches (range less than 5 inches), it's one of the smallest and lightest sports cam. Sports cam 100 is designed to be used on a bow, rifle, shotgun, pistol, or paintball gun, and the like using an accessory mounting kit. Simple controls mean you can be doing the activity instead of fumbling with the camera. There are also 2 zoom settings: 10 M and 30 M, so the camera will capture what you see through the scope. Desired content is recorded on a Micro SD card, and there is a mini USB port to charge a Lithium Ion battery. A remote switch is also included for rifles and shotguns.

Accessory mounts may include, for example: 5/16—24 Bow mount bar, 5/16—24 Shotgun mount—replaces the magazine nut on most common shotguns (This avoids damage to the shotgun from accessory mounts that mount to the barrel), Picatinny rail, and Remote switch for rifle/shotgun mounts, and the like. The Picatinny rail, alternatively known as the MIL-STD-1913 rail, STANAG 2324 rail, or simply “Tactical Rail” is a bracket that provides a standardized mounting platform for small arms weapons. Some embodiments of sports cam 100 include a mount complementary to and compatible with the Picatinny rail (MIL-STD-1913, MILITARY STANDARD: DIMENSIONING OF ACCESSORY MOUNTING RAIL FOR SMALL ARMS WEAPONS (3 February 1995) and change notices, hereby expressly incorporated by reference thereto for all purposes) and other similar proprietary rail systems. Some embodiments include a rear screw mount enabling the system to directly connect to a bow or the like.

Lensing and Zoom: Fitted with a 2.4× telephoto lens to give a vertical field of view (VFOV) of 12 feet (3 m) at 30′ (10 m) distance. This mimics the VFOV you might want using a rifle without a scope. Zoom button gives the camera a 2× zoom, allowing a 12 foot VFOV at 100 feet (30 m). This is intended to mimic a 4-6× scope VFOV.

Resolution, format and modes include: DVI (720×480 native in all zoom modes), and HD: 720P HD, and the like. Micro SD card, up to 32 GB, on board or USB streaming mode. Battery: 400 mah Lithium Ion rechargeable battery. Enough for 3 hours of recording video.

In addition to the mechanical mounting, sports cam 100 is shaped and contoured for weapon use. Further, the electronics and optics providing a zoom capacity to mimic the proper field of view for the distance being targeted. This is done with no reduction is pixels, and therefore no resolution compromises as is typical with digital zoom products. Some preferred embodiments use a digital zoom while maintaining a native pixel count by using a larger sensor, and further use a combination of decimating an image for low magnification and windowing for higher magnification. Essentially some preferred embodiments change a field of view while maintaining the same number of pixels in the video output. Most preferably matching the field of view of a rifle scope with the press of a button. For instance, when a user employs a shotgun to shoot flying clay targets, the user often cannot clay targets with conventional sports cameras, like a GoPro due to their wide field of view. Some sports cams of the present invention reduce the field of view sufficiently so the user obtains a view of the desired action with detail on the target and not having the clay target appear as a dot against the background. It is undesirable when a user is not able to adapt the field-of-view sufficiently so that the sports cam captures the desired elements, features, and details.

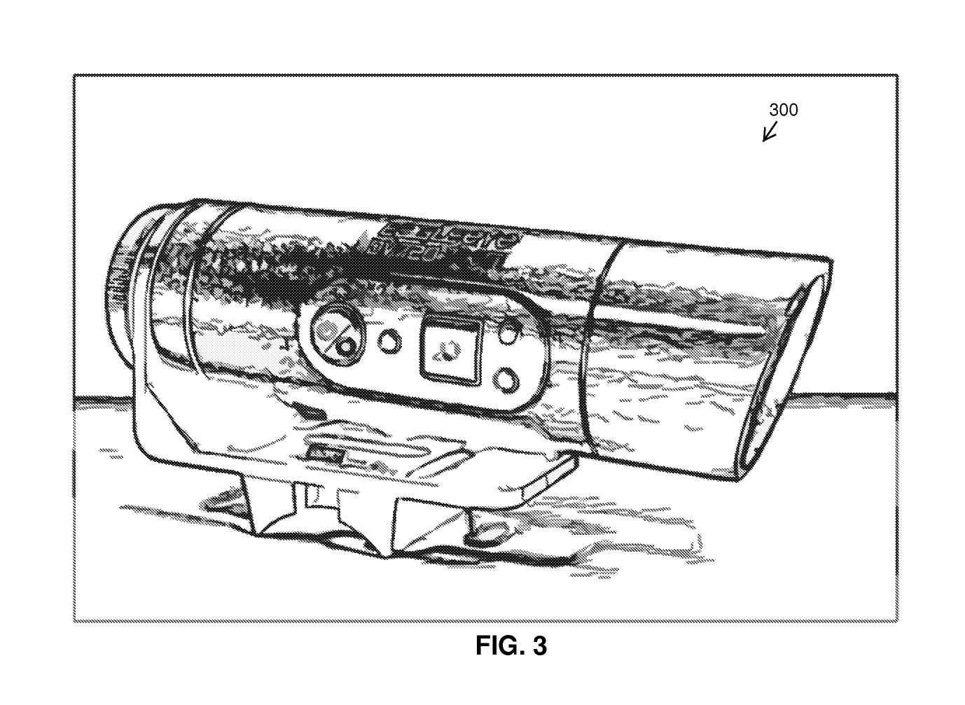

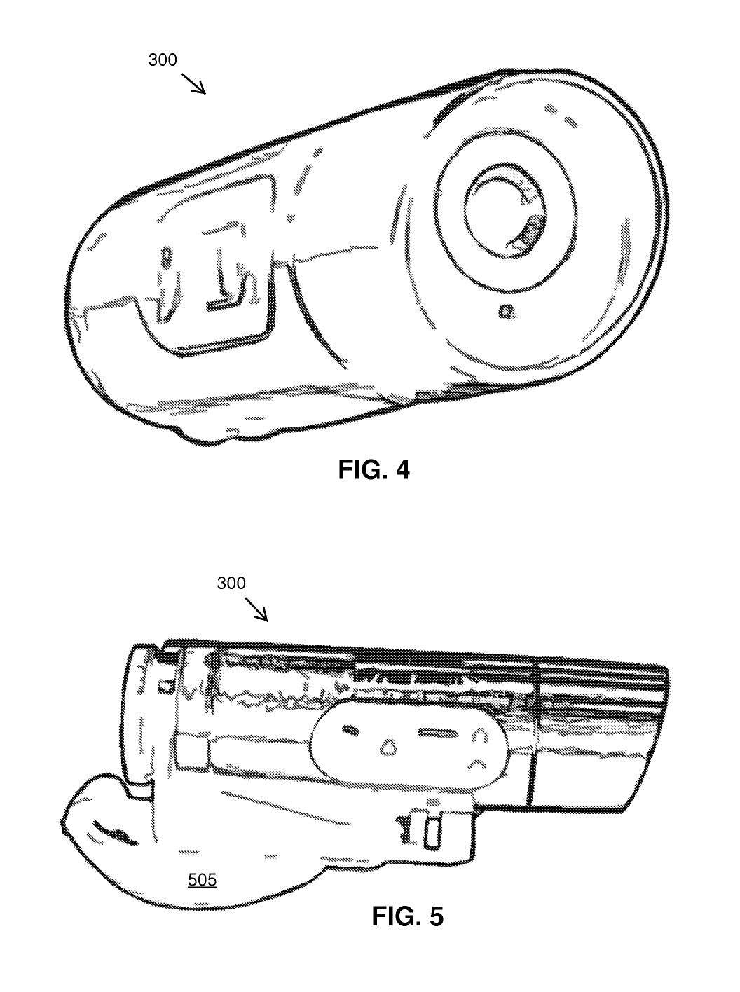

FIG. 3 illustrates a second sports cam 300 designed for outdoor activities, FIG. 4 illustrates a front perspective view of sports cam 300 shown in FIG. 3, and FIG. 5 illustrates a side view of sports cam 300 shown in FIG. 3 including a mounting rail 505. Sports Cam 300 is made for all outdoor activities, including: bicycling, skiing, hiking, snowboarding, skateboarding, surfing, roller skating, horseback riding, and the like. The sleek design of the built in mount allows for streamlined mounting to helmets, handlebars, or wherever you want to use it. Unlike some conventional sportscams, sports cam 300 is not shaped like a brick and will not get caught on low hanging tree branches or other obstructions. It will also not look like a brick on your helmet. With a diameter of 11/8″ and overall length of 3¾″, it's one of the smallest and lightest you'll find. Simple controls mean you can be doing the activity instead of fumbling with the camera. With the press of a button, there is a 2 zoom. Your content is recorded on a Micro SD card, and there is a mini USB port to charge the Lithium Ion battery.

Accessory mounts may include: Handle bar, Helmet, Remote switch (wired), Picatinny rail for weapons mount, and the like. Lensing and Zoom: Fitted with a 55° horizontal field of view lens, 2× zoom with the touch of a button. Resolution, format and modes include: DVI (720×480 native in all zoom modes), HD: 720P HD, and the like. Micro SD card, up to 32 GB, on board or USB streaming mode. Power system includes a 400 mah Lithium Ion rechargeable battery. Enough for 3 hours of recording video.

Some embodiments may include a shutter triggering system for actuating recording images received through the field of view. Images (one or more still images or a series of related serial images configured to produce a video, are recorded when the shutter triggering system is actuated. Some embodiments include a remote manual trigger and some make automatic periodic recordings (e.g., every 20 milliseconds) into a special volatile memory. An accelerometer or other signaling system detecting some event (e.g., a firing of a shot or a launching of an arrow or the like) transfers the contents of the special volatile memory into other memory (e.g., non-volatile memory) where it will not get overwritten. This image thus provides a representation of the scene through the optics close in time, but before, the event.

The system and methods above has been described in general terms as an aid to understanding details of preferred embodiments of the present invention. In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

It will also be appreciated that one or more of the elements depicted in the drawings/figures can also be implemented in a more separated or integrated manner, or even removed or rendered as inoperable in certain cases, as is useful in accordance with a particular application.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims. Thus, the scope of the invention is to be determined solely by the appended claims.

What is claimed as new and desired to be protected by Letters Patent of the United States is:

1. A portable imager for mounting to a targeting apparatus having a first mount and a first target acquisition field of view, comprising:
a substantially circular housing having a length less than 5 inches and a diameter less than 2 inches, said housing defining a cavity and an imaging aperture at a distal end of said housing;
an optic system disposed in said housing and coupled to said imaging aperture, said optic system configured to provide a horizontal field of view less than 60 degrees and a variable focal length;
an imaging system disposed in said housing and coupled to said optic system, said imaging system configured to record one or more images received through said field of view responsive to a control trigger, said imaging system including a memory storing said one or more images;
a rechargeable battery disposed within said housing and coupled to said optic system and to said imaging system;
a control system asserting said control trigger; and
a coupler, complementary to the first mount, configured to align said horizontal field of view with the first target acquisition field of view.

2. The portable imager of claim 1 wherein said variable focal length includes at least a 2 times digital zoom feature without loss of resolution.

3. The portable imager of claim 1 wherein said optic system includes a lensing system configured to provide a vertical field of view (VFOV) of 12 feet at a 30 foot distance.

4. The portable imager of claim 2 wherein said optic system includes a lensing system configured to provide a vertical field of view (VFOV) of 12 feet at a 30 foot distance and wherein said 2 times zoom feature is configured to allow a 12 foot VFOV at 100 feet.

5. The portable imager of claim 1 wherein a second targeting apparatus includes a second mount different from the first mount and a second target acquisition field of view, further comprising a mount adapter, substantially matching the first mount and complementary to said second mount wherein said mount adapter couples said coupler to said second targeting apparatus and is configured to align said horizontal field of view with said second target acquisition field of view.

6. The portable imager of claim 1 wherein said control system includes a remote trigger configured to initiate assertion of said control trigger by said control system.

7. A portable imager for mounting to a targeting apparatus having a first mount and an attached targeting optic system including a first target acquisition field of view, comprising:
a substantially circular housing having a length less than 5 inches and a diameter less than 2 inches, said housing defining a cavity and an imaging aperture at a distal end of said housing;
an optic system disposed in said housing and coupled to said imaging aperture, said optic system configured to provide a horizontal field of view that mimics the first target acquisition field of view;
an imaging system disposed in said housing and coupled to said optic system, said imaging system configured to record one or more images received through said field of view responsive to a control trigger, said imaging system including a memory storing said one or more images;
a rechargeable battery disposed within said housing and coupled to said optic system and to said imaging system;
a control system asserting said control trigger; and
a coupler, complementary to the first mount, configured to align said horizontal field of view with the first target acquisition field of view.

8. The portable imager of claim 7 wherein the attached targeting optic system includes a variable focal length providing a first field of view and a second field of view and wherein said optics system mimics said variable focal length and provides said fields of view of the attached targeting optic system.

9. The portable imager of claim 8 wherein the variable focal length includes at least a 2 times digital zoom feature without loss of resolution.

10. The portable imager of claim 8 wherein said optic system includes a lensing system configured to provide a vertical field of view (VFOV) of 12 feet at a 30 foot distance.

11. The portable imager of claim 9 wherein said optic system includes a lensing system configured to provide a vertical field of view (VFOV) of 12 feet at a 30 foot distance and wherein said 2 times zoom feature is configured to allow a 12 foot VFOV at 100 feet.

12. The portable imager of claim 7 wherein a second targeting apparatus includes a second mount different from the first mount and a second target acquisition field of view, further comprising a mount adapter, substantially matching the first mount and complementary to said second mount wherein said mount adapter couples said coupler to said second targeting apparatus and is configured to align said horizontal field of view with said second target acquisition field of view.

13. The portable imager of claim 7 wherein said control system includes a remote trigger configured to initiate assertion of said control trigger by said control system.
